(19) United States
(12) Patent Application Publication
(10) Pub. No.: US 2009/0094661 A1
(43) Pub. Date: Apr. 9, 2009

(54) Networked personal video recorder backup system

(75) Inventor: Robert A. Boger, Sioux City, IA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/906,577

(22) Filed: Oct. 3, 2007

(51) Int. Cl. H04N 7/173

(52) U.S. Cl. 725/134

(57) ABSTRACT

Methods, systems and computer software products are provided for backing up the recording of television events by a primary recording device when the primary recording device fails or is unavailable. One or more backup video recording devices is specified in a networked household entertainment system for backing up the primary recording device. If the primary recording device is powered down, fails, or is otherwise unavailable at the time the television event is aired, the controller of the networked household entertainment system instructs one of the backup recording devices to record the event.

### BACKGROUND

1. Field

The present invention relates to content recording devices, and more specifically, to systems, methods and computer instructions of recording video content with a personal video recorder.

2. Description of Related Art

An increasing number of households are wired to receive cable television or subscribe to satellite television services with dozens or even hundreds of channels available for viewing. Sometimes a television event or program of interest is scheduled during a time that is inconvenient for viewing. In such instances, people often want to record the television event for later viewing with a personal video recorder (PVR) or other such recording device for recording television content. However, events are sometimes missed because the recording device is powered off, busy with other tasks, malfunctions, or has insufficient recording media available to capture the event.

It can be frustrating to return to the PVR in anticipation of watching a recorded television event only to discover that the recording did not take place. What is needed is a more robust system for recording television events that reduces the chances of missing the event.

### SUMMARY

Embodiments disclosed herein address the above stated needs by providing systems, methods and software for recording television events in a networked household entertainment system. In accordance with various events an instruction is received to record a television event with a video recording device. The recording device has one or more backup recording devices for recording the television event in case the primary recording device is unavailable when the event airs. A controller determines whether the primary recording device is available to record the television event as its air time approaches, and instructs the backup recording device to record the television event if the primary recording device is unavailable.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts an exemplary networked household entertainment system suitable for implementing various embodiments;

FIG. 2 is a block diagram of the exemplary networked household entertainment system of FIG. 1;

FIG. 3 is a flowchart depicting a process of setting up a household entertainment system to implement various embodiments; and

FIG. 4 is a flowchart depicting a method of recording a television event according to various embodiments.

### DETAILED DESCRIPTION

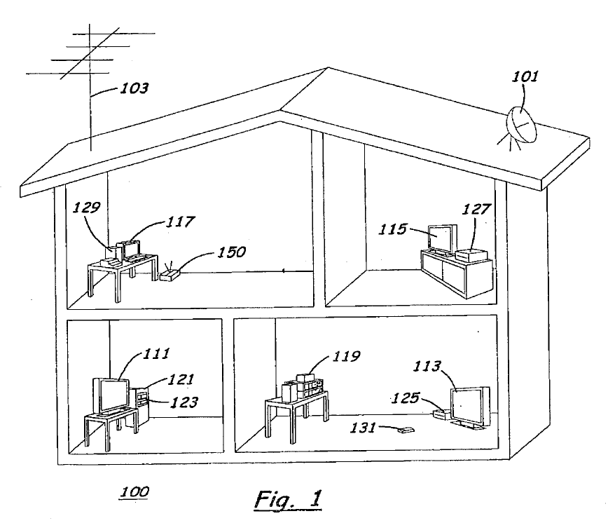

FIG. 1 depicts an exemplary networked household convergence system suitable for implementing various embodiments. An increasing number of households are wired to receive cable television or subscribe to satellite television services. Quite often there are several television sets spread throughout the household for viewing. For example, many households have a television set in their family room, one or more sets in the bedrooms, and sometimes a set in the kitchen, den or other rooms. Many of these same households have several computers spread throughout the house, often interconnected by a network such as a wireless network. Various embodiments disclosed herein advantageously use a computer (or other controller) to interact with the television components to provide backup recording capabilities in the event one of the components fails or is otherwise unavailable.

The household convergence system of FIG. 1 may include a home entertainment or convergence system such as the Gateway Destination System described in U.S. Pat. No. 7,134,133, the contents of which are incorporated herein by reference in their entirety. The Gateway Destination System uses the DestiVu user interface manufactured and sold by Gateway, Inc. In various implementations of the Gateway Destination System the computer system 117 is a fully functional computer interfaced with one or more of the television sets 111-115, while at the same time providing TV viewing of broadcast, cable, satellite, VCR, digital disk, or other broadcast media on the computer of the Gateway Destination System. This enables a user the combined access to both television programs and information on the computer system 117, as well as computer related functionality such as Internet access, gaming, word processing, and the like.

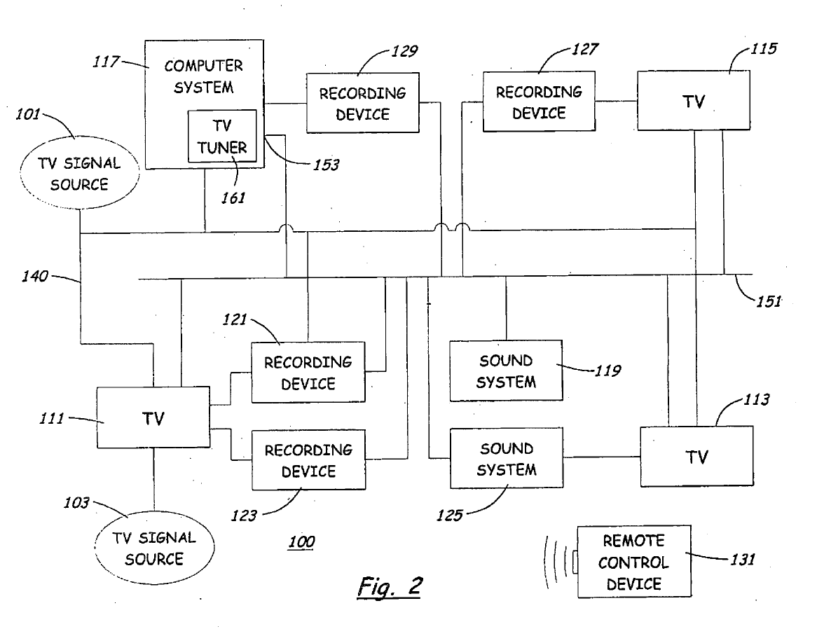

The reference numerals of FIG. 1 which are similar or identical to the reference numerals of FIG. 2 indicate like, similar, or identical components or features. The satellite antenna 101 is configured to receive television satellite signals and provide the signals to other components of the home entertainment system. For example, the satellite antenna 101 typically receives digital television signals from such sources such as DirecTV™ or Primestar™. Typically, the satellite antenna 101 provides a downconverted-spectrum signal to the household via a coaxial cable or other suitable communication medium. In addition to satellite antenna 101 the household may receive local television broadcast signals using a broadcast antenna 103. The broadcast antenna 103 may receive analog television broadcast signals conforming to standard formats such as National Television Systems Committee (NTSC) signals. Typically, the broadcast antenna 103 is mounted centrally, either inside or outside of the home, and connected to the various television sets with antenna cable or coaxial cable.

The components receiving the satellite television signal in FIG. 1 may include one or more of the television sets 111-115. The television sets 111-115 are each associated with one or more of the video recording devices 121-129. The term video recording device as used herein is intended to include any device configured to be connected to a source of television signals (e.g., a television set, a television tuner, or the like) and capable of recording television signals for later playback. Accordingly, the various embodiments may be implemented with virtually any recording device, such as, for example, a personal video recorder (PVR), a digital video recorder (DVR), a video cassette recorder (VCR), or other like type of recording device known to those of ordinary skill in the art to be capable of recording television signals for later playback. A household entertainment system may also include an audio system 119 for playing and recording audio, e.g., radio signals, compact disks (CDs), reel to reel, cassette tapes, or the like. Such an audio system 119 may be coupled to the television set 113 to play the audio portion of the television signal while a program is being watched.

One or more computer systems 117 may be incorporated into the household entertainment system. Gateway's Destination System includes a computer as a controller, an integral component of the system. The computer system 117 is networked, or otherwise communicatively connected, with the other components of the household entertainment system, either via a wired or wireless network. In FIG. 1 a wireless router 150 is used to broadcast a wireless network connecting the various household entertainment system components. In other implementations the components may be connected by a wired network using cables conforming to any of several standards, e.g., Ethernet, CAT5, FireWire, USB, or the like. In some embodiments the components may be implemented in a peer to peer network without a central router.

FIG. 2 is a block diagram of the exemplary networked household entertainment system of FIG. 1. In the configuration of FIG. 2, the computer system 117 includes a television tuner assembly 161. As such, the computer system 117 may include a tuner, tuner circuitry, or card capable of both tuning to any of multiple channels and receiving television information or signals in the form of the NTSC (National Television Standards Committee) or PAL (Phase Alteration Line) forms, from any medium such as from a cable system or from a digital satellite system. The tuner circuitry of television tuner 161 may either be incorporated into the enclosure of computer system 117, or signals from TV tuner 161 may be provided to computer system 117 as an input. The television sets 111-115—and in some embodiments, the computer system 117—typically contain circuitry and software to process signals from the TV signal source 101-103. Television sets 111-115 may demodulate and decode the received television signal to produce a signal suitable to drive a display screen of the television for viewing by a user. In some embodiments the computer system 117 may work in conjunction with television sets 111-115, but not contain a TV tuner 161 as part of the computer.

In the block diagram of FIG. 2 the network connecting the various components of the household entertainment system is represented by network connections 151. As mentioned above for FIG. 1 the network connecting the various components may either be wired (as shown in FIG. 2) or wireless (as per FIG. 1), so long as the components can communicate with each other or with the computer system 117. Television cables 140 provide television signals to the various television sets 111-115. The TV signal sources 101 and 103 may be inputs from one, or a combination of, a satellite dish antenna, a cable television system, a broadcast antenna, or any other sources of television programming and events know those of ordinary skill in the art. The broadcast antenna may either be one centralized antenna feeding into the various television sets 111-115, or sets of individual antennas on each set (e.g., rabbit ear antennas), or a combination of both.

The various components of the household entertainment system 100 may receive user inputs via a remote control device 131. Generally, the remote control device 131 is embodied in the form of a handheld sized device with standard television controls and a numeric keypad and controls for navigating around electronic program guide (EPG) menus displayed on the television sets 111-115. The remote control device typically communicates wirelessly using IR (infrared) control signals, but could be configured to use RF (radio frequencies). In addition to the remote control device, a full function remote control keyboard may be provided with additional standard television and VCR controls, or a pointing device (e.g., in the form of a touchpad).

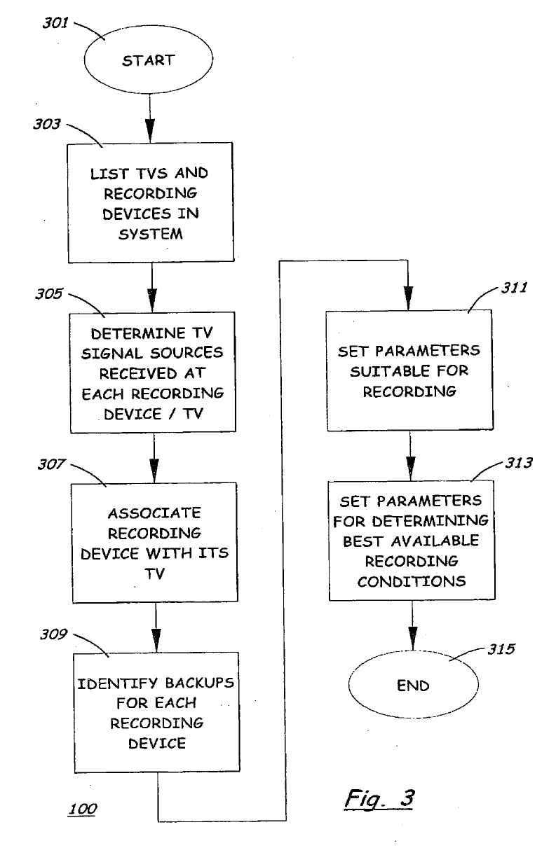

FIG. 3 is a flowchart depicting a method 300 of setting up a household entertainment system to implement various embodiments. The method begins in 301 and proceeds to 303 to develop a list of the various components in the system. The list may be created either by detecting the various television sets and recording devices (such as PVRs), or by receiving user entries listing the components, or a combination of both. The user may wish to assign descriptive names to the various components, such as family room TV set, kitchen TV set, or the like. The list may be part of a database maintained or accessible by the controller, e.g., computer system 117 of FIG. 2. The database may also contain the addresses of each component to facilitate communication with the controller, as well as parameters for the system such as the setup parameters determined during the process of FIG. 3. Once a list has been created for the various television sets and PVRs of the system the method proceeds from 303 to 305.

In 305 the various TV signal sources received at each component is determined. For example, referring back to FIG. 2, it is determined that television sets 111-115, video recording devices 121-129, and the computer system 117 each receive the TV signal source 101. This may be implemented by using protocols known to those skilled in the art, such as, for example, Universal Plug and Play (UPnP). The TV signal source 103 is received only by television sets 111 and video recording devices 121-123. At other times the video recording device may directly have an input from the source of the television signal. For example, as shown in FIG. 2 video recording device 123 receives TV signal source 101 via television sets 111, while video recording device 121 is directly wired to TV signal source 101. Once it has been determined in 305 what various TV signal sources each component receives the method proceeds to 307.

In 307 each video recording device is associated with one of the television sets. In this way, if a channel is unavailable to a video recording device because the associated television set is being watched, the backup chosen to record the desired event can be selected from among the video recording devices associated with different television sets (not being watched at the moment). Once the assignment of video recording devices to television sets has been determined the method may proceed to 309. In 309 one or more backups may be assigned to each video recording device. For example, the backup to video recording device 121 could be recording device 123 and 125. Assigning a list of more than one backup allows the controller to search down the list for an available video recording device suitable for recording the television event, in case the primary backup recording device is not available. In some embodiments the components may be implemented in a peer-to-peer network without a central controller. In such embodiments a primary recording device broadcasts the scheduled recording to every device, and the backup devices wait for the primary recorder to broadcast information that the recording successfully started. If the start time passes with no broadcast message, the backup devices may be set to record the scheduled program. For example, a first backup device may be specified to start recording broadcasts a message, and then the other backup devices stop trying to record the event. Once each video recording device has been assigned one or more backup recording devices the method proceeds to 311. Optionally, instead of requiring the preassignment of backup video recording devices for one or more of the recording devices, the selection of one or more backup video recording devices may occur at a later time, such as when the primary recording device is detected to be unavailable.

In 311 parameters may be set to quantify whether or not a particular video recording device is available for recording a specified event. By “available” it is meant that the recording device is powered up and is suitably configured to record the event. The parameters may include the desired quality of the received television signal, whether there is enough capacity to record the event (e.g., whether the recording device has a disk in it), a default rule for the situation in which the associated television is being watched, and other such parameters that may affect the recording of the event. Regarding the desired quality of the received television signal, it may sometimes occur that a particular recording device is not properly receiving an adequate signal for recording the event, e.g., because of the failure of a low noise amplifier, a loose connection, or other equipment problem. For recording devices with the capability to measure signal quality, a minimum signal quality may be specified as a parameter for the adequate signal. In such embodiments the minimum signal quality must to be met before recording with that device. If the signal quality falls below the minimum, the backup recording devices is used to record the event. Parameters may also be specified to handle situations that arise in which the associated television is being watched as the time to record the event approaches. For example, one default rule can be to simply change the channels and begin recording regardless of whether anyone is watch television or not. Another default rule can be to use the backup recording device if a user is watching the associated television. One other default rule may be to flash a warning, providing the user to select whether or not the begin recording, before either recording or switching to a backup recording device. In 311 it is also determined when to measure the parameters for determining whether the recording device is suitable for recording the event. For example, it may be specified that the primary recording device will be checked for suitability one minute before the event begins (or 20 minutes, one hour, etc.). Once the various parameters have been specified in 311 the method proceeds to 313.

Regarding 313, situations may arise in which neither the primary recording device nor any of its backups meet the parameters for the recording, as specified in 311. Rather than foregoing the opportunity to record the event, a set of minimum parameters can be specified so that a recording is made of the event—even though the recording with be less than optimal. In 313 the parameters defining the minimum required conditions are determined, for example, by receiving inputs from a user specifying the parameters or using default values provided by the system. The parameters may include a minimum available amount of storage space, a minimum signal quality, a maximum amount of the program missed (e.g., due to a power outage, temporary signal loss, etc.) or other like parameters affecting the quality of the recorded event. Once the parameters defining the minimum required conditions have been determined in 313 the method proceeds to 315 and ends.

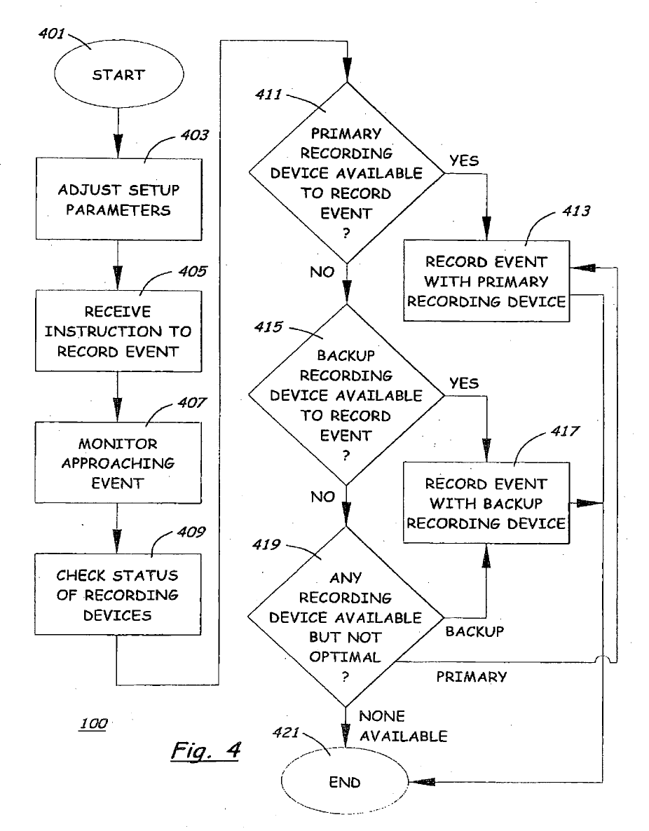

FIG. 4 is a flowchart 400 depicting a method 400 of recording a television event according to various embodiments. The method begins at 401 and proceeds to 403 where an instruction is received to record a television event. A television event may be a television program, a movie, a sporting event, or any other television content broadcast, transmitted or otherwise sent for television viewing. The instruction to record the event may be received by detecting user inputs to a remote control device, inputs to the controls of a recording device, or by entering the recording instructions into the controller of the networked household entertainment system, e.g., the computer system 117. In some embodiments the controller (e.g., computer system 117 of FIG. 2) may detect keystroke inputs from a user with instructions to record the television event. In other embodiments a remote control device (e.g., handheld wireless remote) may be manipulated by the user to provide instructions to record the television event. This may be done with the aid of electronic program guide (EPG) screens displayed on the television set. The instructions to record the television event, if entered into the recording device itself, may be communicated to the controller, for example, via a network such as network 151 of FIG. 2. Typically, the instructions to record the event are stored in the recording device itself, and may also be communicated to the controller of the networked household entertainment system.

Once the instructions to record the event have been received in 403 the method proceeds to 405 to monitor the approaching event. In some embodiments the approaching event is monitored until a predefined amount of time before the scheduled recording of the event before checking the recording device for its availability to record the event. The approaching event may be monitored by setting a timer or checking a clock to determine when the predefined amount of time before the scheduled recording has arrived. The predefined amount of time, or the scheduled time at which the recording device is checked, may be one of the parameters specified in 311. Upon the arrival of the predefined time the method proceeds from 405 to 407 to check the status of the recording device for suitability to record the television event. The parameters that define the recording device's suitability for recording the event may be specified in accordance with 311 of FIG. 3, discussed above. For example, the parameters that may be checked can include the quality of the received television signal, the available capacity for recording the event, whether the associated television is being watched, and any other parameters affecting the recording of the event.

Upon checking the primary recording device for suitability in 407, the method then proceeds from 407 to 409. In 409, if the primary recording device is determined to be suitable for recording the event the method proceeds along the “YES” branch to 411. In 411 the event is recorded in the specified manner using the primary recording device. Once the event has been recorded in 411 the method proceeds to 419 and ends. Back in 409, if it is determined that the primary recording device is not suitable for recording the event, the method proceeds along the “NO” branch to 413. In 413 it is determined whether the specified backup recording device is suitable for recording the television event. Optionally, if a backup video recording device has not been predetermined or preselected, then a search for a suitable backup recording device may be initiated. Checking for the backup recording device (if the primary recording device is unavailable) is done in response to the instruction to record the event. Instead, one or more backup recording devices are associated with each recording device that may be used as a primary recording device and instructed to record an event. In this way, if the primary recording device fails the backup is ready to take over recording the event without a need to set the backup up each time an event is recorded. In 413, if the backup recording device is determined to be suitable for recording the event the method proceeds along the “YES” branch to 415 and the event is recorded using the backup recording device. In view of the hundreds of channels available by satellite and cable providers, it may be the case that a particular event is available from another television signal source, other than the one specified. In such instances the system may check for other television signal sources of the event (aside from the source to the primary recording device) to be used by the backup recording device in case the primary source is not available. Once the event has been recorded in 411 the method proceeds to 419 and ends.

It may be the case that the first backup recording device checked by the controller turns out to be unavailable for recording the event. In accordance with various embodiments there may be more than one backup recording device specified for recording the event. The backup recording devices are typically specified in a hierarchy, for example, the first backup recording device, the second backup recording device, and so on. If the first recording device is not available, the controller typically checks the second backup recording device, going through the various backup recording devices on down the list until one if found to be suitable for recording the event. Once the availability of all of the backup recording devices has been checked, and no devices are determined to be available—that is, no devices to conform to the parameters required for making a recording (e.g., signal strength, recording capacity, etc.)—the method proceeds along the “NO” branch from 413 to 417.

In 417 it is determined whether any recording devices are available for recording the event, even though they may not conform to all the desired parameters for recording. For example, one of the recording devices may be available, but receiving the broadcast television signal at a signal strength or quality of slightly less than the specified parameter. In such situations it may be deemed better to record the event, even though the signal strength is sub-optimal, rather than forego the opportunity to make a recording. The controller will typically not check for suboptimal recording device availability until it has checked the availability of all the backup recording devices specified in the list. The recording device, either the primary recording device or one of the backups, with the best sub-optimal suitability for recording the event will typically be selected to record the event. If the primary recording device is determined to be available with the best sub-optimal conditions the method proceeds along the “PRIMARY” branch from 417 to 411 to record the event. Similarly, if one of the backup recording devices is determined to have the best available sub-optimal conditions the method proceeds along the “BACKUP” branch from 417 to 415 to record the event. If neither the primary recording device nor any of the backup recording devices are available, either with optimal conditions or sub-optimal conditions, the method proceeds along the “NONE AVAILABLE” branch from 417 to 419 and ends.

The term television “events” has been used throughout this disclosure in explaining the various embodiments. A television event may be a television program, a movie, a sporting event, or any other television content broadcast, transmitted or otherwise communicated for television viewing. A television event may be broadcasted by terrestrial broadcast station, transmitted from a satellite, sent via a cable television system, or otherwise communicated to a television user. The term “television set” has also been used throughout this disclosure, e.g., television sets 111-115. The term television set is intended to encompass any device suitable for viewing television events from a television signal source. A television set is typically a consumer electronic device with television tuner circuitry and a display screen (e.g., flat screen, plasma display, cathode ray tube screen, or the like). The term television set also encompasses discrete component parts interconnected to display television events, for example, a television display monitor or plasma display connected to a television tuner assembly. The terms “recording device” and “video recording device” have been used interchangeably throughout this disclosure. These terms encompass any device capable of recording a television event, including, for example, personal video recorders (PVR), digital video recorders (DVR), video cassette recorders (VCR), or other like types of devices know to those of ordinary skill in the art to be capable of recording television signals for later playback. The term “available” has also been used throughout this disclosure in regard to whether or not a particular video recording device is presently suitable for recording a specified event. By “available” it is meant that the recording device is powered up (or optionally may be remotely powered up), can be accessed, is receiving an adequate signal, has sufficient recording capacity, and/or is suitably configured to record the event. Other parameters for further defining the availability of a recording device may be used in accordance with various embodiments.

Various activities as described above may be included, excluded, or performed in a different order, in accordance with various embodiments within the scope of the invention. For example, block 405 may be omitted so that, instead of monitoring the approaching event, the method is performed by attempting to record the event at the time it is scheduled. If it is discovered at that time that the primary recording device is unavailable, the system checks the availability of a suitable backup recording device. In such embodiments, the flowchart of FIG. 4 is configured to proceed directly from 403 (receive instruction to record) to block 409 (primary recording device available?). Other activities may be included, excluded, or performed in a different order, with the rest of the elements and activities remaining within the scope of at least one exemplary embodiment.

The invention may be implemented using a controller that includes any sort of processing units, processors, microprocessors (e.g., the microprocessor of computer system 117 FIG. 2) or logic circuitry capable of performing the stated functions and activities. For example, the controller may be embodied as a microprocessor, microcontroller, DSP (digital signal processor), RISC (reduced instruction set computer), or any other type of controller that one of ordinary skill would recognize as being capable of performing the functions described herein. A controller in accordance with at least one exemplary embodiment can operate in response to a set of computer instructions for performing or controlling the various activities of the methods disclosed herein. Such instructions may include one or more computer software programs stored (embodied) on computer-readable medium such as the memory or storage of computer 117, e.g. a hard disk, CD, flash memory, ram, or other computer readable medium as recognized by one of ordinary skill in the art, or the computer software programs may be transmitted wirelessly to the processing unit. The computer software programs can aid or perform the steps and activities described above. For example computer programs in accordance with at least one exemplary embodiment may include: source code for detecting the suitability of the primary and backup recording devices to record the event, and instructing the primary and backup recording devices to record the event. There are many further source codes that may be written to perform the stated steps and procedures above, and these are intended to lie within the scope of exemplary embodiments.

The use of the word “exemplary” in this disclosure is intended to mean that the embodiment or element so described serves as an example, instance, or illustration, and is not necessarily to be construed as preferred or advantageous over other embodiments or elements. The description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

What is claimed is:

1. A method for recording a television event comprising:
receiving an instruction to record the television event with a primary recording device;
determining whether said primary recording device is available to record the television event; and
recording the television event with a backup recording device if it is determined that the primary recording device is not available to record the television event.

2. The method of claim 1, additionally comprising defining a backup recording device to back up said primary recording device for recording the television event.

3. The method of claim 1, additionally comprising, if it is determined that the primary recording device is not available to record the television event, selecting a backup recording device to record the television event.

4. The method of claim 1, additionally comprising determining if the television event is recordable by the backup recording device by checking signal sources available to the backup recording device to determine if the available signal sources carry the television event.

5. The method of claim 1, wherein a plurality of backup recording device are available, and additionally comprising selecting the backup recording device of the plurality of backup recording devices having a most suitable signal for recording.

6. The method of claim 1, wherein the primary recording device and the backup recording device are connected to a controller by a network; and
wherein the determination of whether said primary recording device is available to record the television event is performed by the controller.

7. The method of claim 6, wherein the controller is a computer system and the network is a wireless network.

8. The method of claim 6, wherein the instruction to record the television event is received by the primary recording device and communicated to the controller via the network.

9. The method of claim 1, further comprising:
monitoring a time of the television event as it approaches a scheduled time;
checking the recording device for availability to record the event a predefined amount of time before a scheduled time of the event arrives.

10. The method of claim 1, wherein the primary recording device is not available due to a reason selected from a group consisting of: because the primary recording device is not powered, because the primary recording device is not receiving an adequate signal for the television event, and because another television event is being watched on a signal source associated with the primary recording device.

11. The method of claim 1, wherein the backup recording device is a second backup recording device, the method further comprising:
determining whether a first backup recording device is available to record the television event;
wherein the recording of the television event comprises recording the television event with the second backup recording device if it is determined that the primary recording device and the first backup recording device are not available to record the television event.

12. A set of computer instructions stored on a computer readable medium for recording a television event, wherein executing the computer instructions causes the computer to:
receive an instruction to record the television event with a primary recording device;
define a backup recording device to back up said primary recording device for recording the television event;
determine whether said primary recording device is available to record the television event; and
record the television event with the backup recording device if it is determined that the primary recording device is not available to record the television event.

13. The set of computer instructions of claim 12, wherein the primary recording device and the backup recording device are connected to a controller by a network; and
wherein the determination of whether said primary recording device is available to record the television event is performed by the controller.

14. The set of computer instructions of claim 13, wherein the controller is a computer system and the network is a wireless network.

15. The set of computer instructions of claim 13, wherein the instruction to record the television event is received by the primary recording device and communicated to the controller via the network.

16. The set of computer instructions of claim 12, further comprising:
monitor a time of the television event as it approaches a scheduled time;
check the recording device for availability to record the event a predefined amount of time before a scheduled time of the event arrives.

17. The set of computer instructions of claim 12, wherein the primary recording device is not available due to a reason selected from a group consisting of: because the primary recording device is not powered, because the primary recording device is not receiving an adequate signal for the television event, and because another television event is being watched on a signal source associated with the primary recording device.

18. The set of computer instructions of claim 12, wherein the backup recording device is a second backup recording device, the method further comprising:
determine whether the primary backup recording device is available to record the television event;
wherein the recording of the television event comprises recording the television event with the second backup recording device if it is determined that the primary recording device and the first backup recording device are not available to record the television event.

19. A system for recording a television event comprising:
means for instructing a primary recording device to record the television event;
storage memory configured to store a list of one or more backup recording devices;
communication port configured to communicate with the primary recording device and the one or more backup recording devices; and
a controller configured to determine whether the primary recording device is available to record the television event;
wherein the controller instructs one of said one or more backup recording devices to record the television even in response to determining that the primary recording device is not available to record the television event.

20. The system of claim 19, wherein the primary recording device and the one or more backup recording device are connected to the controller by a network; and
wherein the determination of whether said primary recording device is available to record the television event is performed by the controller.

21. The system of claim 20, wherein the system is a computer system and the network is a wireless network.

22. The system of claim 20, wherein an instruction to record the television event is received by the primary recording device and communicated to the controller via the network.

23. The system of claim 19, wherein the controller is further configured to:
monitor a time of the television event as it approaches a scheduled time;
checking the recording device for availability to record the event a predefined amount of time before the scheduled time of the event arrives.

24. The system of claim 19, wherein the primary recording device is not available due to a reason selected from a group consisting of: because the primary recording device is not powered up, because the primary recording device is not receiving an adequate signal for the television event, and because another television event is being watched on a signal source associated with the primary recording device.

25. The system of claim 19, wherein the backup recording device is a second backup recording device, the controller being configured to further:
determine whether the primary backup recording device is available to record the television event;
wherein the recording of the television event comprises recording the television event with the second backup recording device if it is determined that the primary recording device and the first backup recording device are not available to record the television event.
